(19) United States
(12) Patent Application Publication
(10) Pub. No.: US 2010/0002269 A1
(43) Pub. Date: Jan. 7, 2010

(54) METHOD FOR DISPLAYING IMAGE INFORMATION OF SCANNER ON DISPLAYER AND SCANNER USING THE SAME

(75) Inventor: Jian Shen, Suzhou (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN COUNTY (TW)

(21) Appl. No.: 12/388,909

(22) Filed: Feb. 19, 2009

(30) Foreign Application Priority Data
Jul. 4, 2008 (TW) TW97125211

(51) Int. Cl. H04N 1/32; H04N 1/04

(52) U.S. Cl. 358/442; 358/498

(57) ABSTRACT

A scanner is provided, which has a scan unit for scanning and producing image information, a storage unit for storing the image information and a first port for connection to an electrical device.

### CROSS REFERENCE TO RELATED APPLICATIONS

This Non-provisional application claims priority under 35 U.S.C. 119(a) on Patent Application No(s). 97,125,211, filed in Taiwan, Republic of China on Jul. 4, 2008, the entire contents of which are hereby incorporated by reference.

### BACKGROUND OF THE INVENTION

1. Field of the Invention

The present invention relates to a scanner, and in particular relates to a method for displaying image information obtained by a scanner on a digital picture frame.

2. Description of the Related Art

There are many portable scanners for scanning business cards or photos in the market. Although they help users increase work efficiency, some shortcomings still remain to be overcome.

After a scan procedure is performed by a portable scanner 101 as shown in FIG. 1, connection to a computer 100 using transmission wires is required before scanned results are shown on the computer 100. Thus, if a computer 100 is not available, a user will not be able to view the scanned results. Thus, making portability inconvenient as a user must carry around the portable scanner 101 and the computer 100 to view scanned results.

Meanwhile, various kinds of digital picture frames 102 are available for users. As an independent image displayer, the digital picture frame 102 makes viewing more convenient for users. Therefore, a portable scanner with the capability to connect to and operate with a digital picture frame is desirable.

### BRIEF SUMMARY OF INVENTION

A scanner having a scan unit for scanning and producing image information, a storage unit for storing the image information, and a first port for connecting to an electrical device is provided.

Additionally, a method for displaying image information of a scanner on a display apparatus is provided, wherein the method comprises scanning an object and obtaining the image information, storing the image information in a storage unit, connecting the scanner to the display apparatus, acquiring the image information from the storage unit and transmitting the image information to the display apparatus for displaying.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is a schematic diagram of a computer, a scanner and a digital picture frame.

FIG. 2A is a schematic diagram of an embodiment of a scanner according to the present invention.

FIG. 2B is a flow chart of a method for displaying image information on the display apparatus according to the present invention.

FIG. 3 is a schematic diagram of another embodiment of a scanner according to the present invention.

FIG. 4A illustrates scanning of a document in a direction.

FIG. 4B illustrates display of an image on the digital picture frame in a direction.

FIG. 4c illustrates displaying the image on the digital picture frame in another direction.

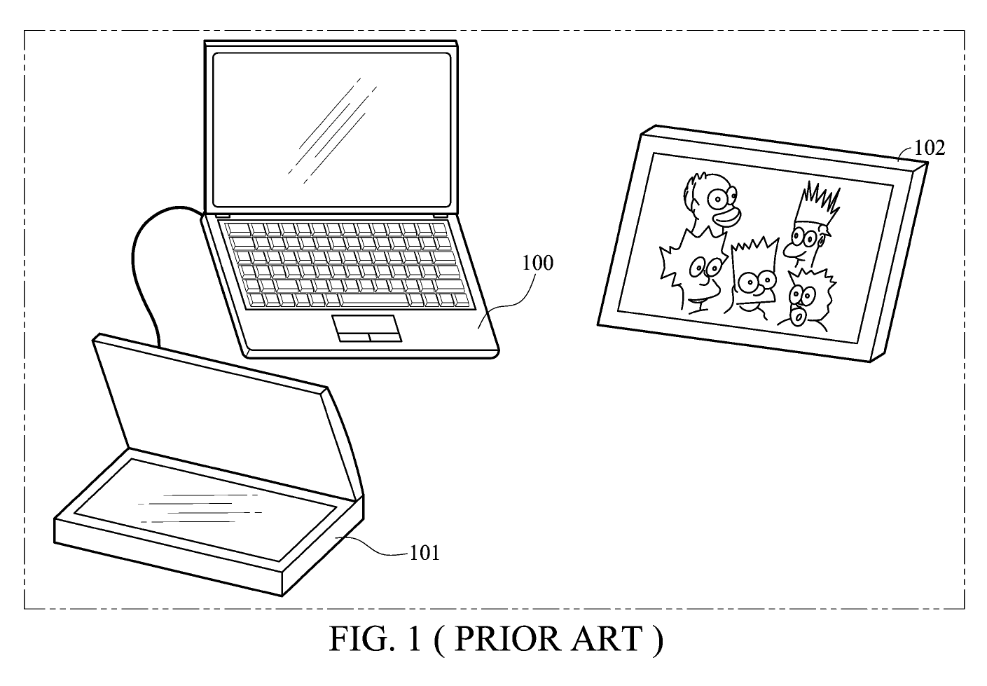

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

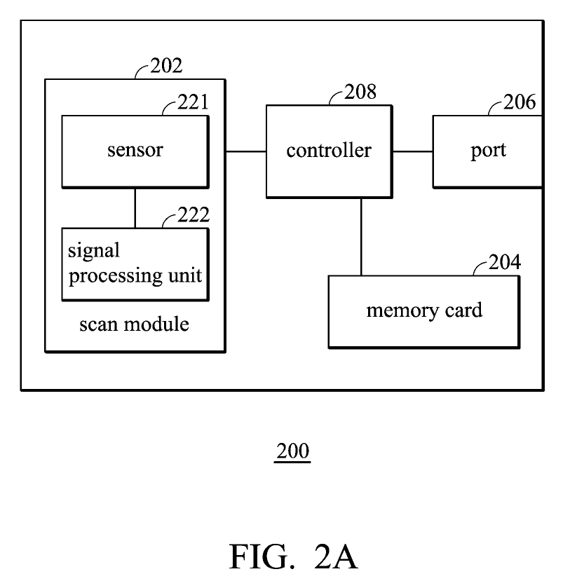

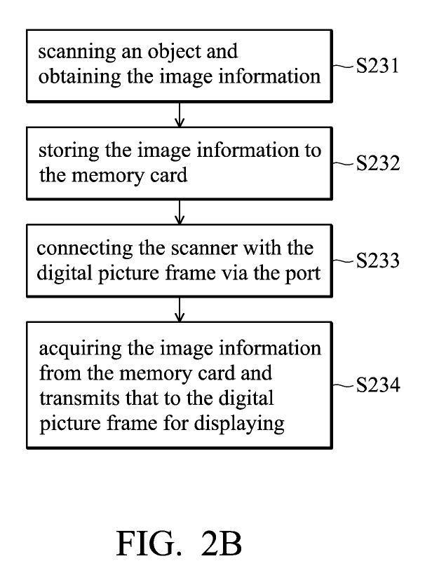

FIG. 2 shows a schematic diagram of an embodiment of a scanner 200 according to the present invention. In a preferred embodiment, the scanner 200 is a small-sized portable scanner for scanning small documents such as business cards or photos, but the invention is not limited thereto.

The scanner 200 comprises a scan module 202, a memory card 204, a port 206 and controller 208. The scan module 202 further comprises a sensor 221 and a signal processing unit 222 for scanning documents and producing image information. The mechanism for scanning is described in brief. The sensor 221, which can be a contact image sensor (CIS), is used for transforming optical images into electrical signals, while the signal processing unit 222, which can be an analog front end (AFE), is used for receiving and digitalizing the electrical signals into the image information.

The port 206 of the present invention is used for connection with other electrical devices, and the interface therebetween, for example, can be a universal serial bus (USB).

There are three modes in the controller 208 of the present invention to deal with three different connection types. The first connection type occurs when the port 206 is connected with no electrical device. In this mode, the image information produced will be stored in the memory card 204 by the controller 208 of the scanner 200. The memory card 204 here can be a non-volatile memory such as flash memory, which does not require any power for maintaining the data storage. Thus, the image information stored in the memory card 204 will not be erased when the power of the scanner 200 is cut off.

The second connection type occurs when the port 206 is connected to an electrical device which has a display apparatus. In this mode, when the controller 208 confirms that the electrical device has a display function, the controller 208 reads the image information stored in the memory card 204 and then outputs the image information to the display apparatus. More specifically, the display apparatus can be a digital picture frame comprising at least a screen, a display unit and a storage medium. The display unit can transform the data in the storage medium into a picture and show it on the screen. The digital picture frame has a port which can be a USB like the port 206. When the scanner 200 is connected to the digital picture frame, the port 206 of the scanner 200 and the port of the digital picture frame are connected, wherein the controller 208 can transmit the image information to the digital picture frame via the port 206, and the display unit of the digital picture frame can transforms the image information into pictures and show the pictures on the screen. For convenience, those skilled in the art can design one of the port 206 of the scanner 200 and the port of the digital picture frame as a USB plug and the other a USB slot so that the scanner 200 can directly connect with the digital picture frame without additional wires or cables.

The third connection type occurs when the scanner 200 is connected to an electrical device which is computer. In this mode, the scanner 200 performs typical functions as a conventional scanner, wherein the computer operates the scanner 200 through the port 206 and the scanner 200 transmits the image information produced from scanning to the computer for additional processing. Note that although the scanner 200 in the third mode performs the typical functions as a conventional scanner, a conventional scanner can not perform the first and second functions as the present invention.

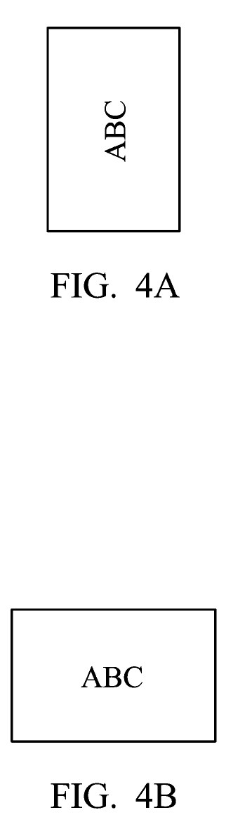

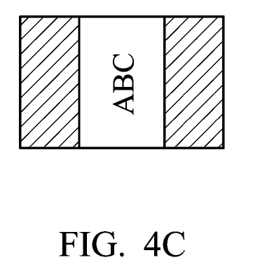

For the second connection type, the image information outputted by the scanner 200 usually must be adjusted for a digital picture frame. For example, due to the structural limitations of the portable scanners 200, a document has to be processed for scanning in a direction as shown in FIG. 4A, but the image of the document can be displayed as shown in FIG. 4B or FIG. 4C. The image shown in FIG. 4B, which is corresponding to the size of the digital picture frame, is regarded as one in a better direction than the image shown in FIG. 4C. Therefore, the scanner 200 in the present invention further comprises a function by which the controller 208 can rotate the image information before storing it to the memory card 204 or outputting it to the digital picture frame.

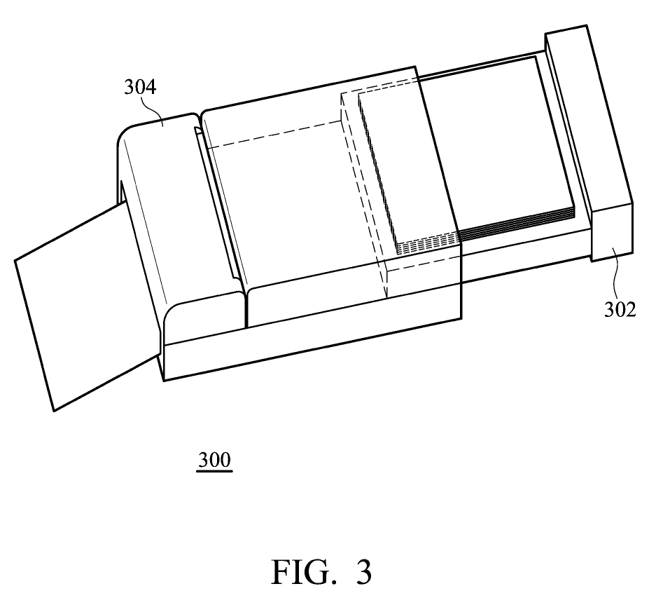

FIG. 3 shows a schematic diagram of another embodiment of a scanner according to the present invention. In this embodiment, in addition to having all of the components comprised in the scanner 200 shown in FIG. 2, the scanner 300 further comprises a paper drawer 302 and an auto paper feeding module 304. The paper drawer 302 is used for documents such as business cards or photos to be placed in, and the auto paper feeding module 304 is used for automatic and repeated feeding in and out documents before and after scanning, respectively.

The present invention further provides a method for displaying image information of a scanner on a display apparatus. FIG. 2B is a flow chart of the method according to the present invention. Referring to FIGS. 2A and 2B, in the second connection type for the scanner 200, in step S231,the scan module 202 of the scanner 200 scans an object and obtains image information. Instep S232, the controller 208 of the scanner 200 stores the image information to the memory card 204 and in step S233, the user connects the scanner 200 to the digital picture frame via the port 206. In step S234, the controller 208 acquires the image information from the memory card 204 and transmits it to the digital picture frame for displaying.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner, comprising:
a scan unit for scanning and producing image information;
a storage unit for storing the image information; and
a first port for connecting to an electrical device.

2. The scanner as claimed in claim 1 further comprises a controller, and when the first port is connected to the electrical device and the electrical device is a display apparatus, the controller outputs the image information to the display apparatus.

3. The scanner as claimed in claim 2, wherein the display apparatus comprises:
a second port;
a screen; and
an image display unit,
wherein when the first port and the second port are connected with each other, the image display unit converts the image information into an image to be shown on the screen.

4. The scanner as claimed in claim 1, wherein the storage unit is a non-volatile memory.

5. The scanner as claimed in claim 2, wherein the controller rotates the image information in accordance with the display apparatus.

6. The scanner as claimed in claim 1 further comprises:
a paper drawer for a plurality of documents to be placed in; and
an auto paper feeding module, used for automatically feeding in and out documents before and after scanning, respectively.

7. A method for displaying image information of a scanner on a display apparatus, comprising:
scanning an object and obtaining the image information;
storing the image information in a storage unit;
connecting the scanner to the display apparatus; and
acquiring the image information from the storage unit and transmitting the image information to the display apparatus for displaying.

8. The method for displaying image information of a scanner on a display apparatus as claimed in claim 7 further comprises disposing the storage unit in the scanner.

9. The method for displaying image information of a scanner on a display apparatus as claimed in claim 7 further comprises using a non-volatile memory as the storage unit.

10. The method for displaying image information of a scanner on a display apparatus as claimed in claim 7 further comprises rotating the image information in accordance with the display apparatus after acquiring the image information from the storage unit.
